(19) United States
(12) Patent Application Publication
(10) Pub. No.: US 2011/0302741 A1
(43) Pub. Date: Dec. 15, 2011

(54) Drive Wheel and Bearing

(75) Inventor: Charles P. Tabler, Cincinnati, OH (US)

(73) Assignee: OCS IntelliTrak, Inc., Cincinnati, OH (US)

(21) Appl. No.: 13/216,644

(22) Filed: Aug. 24, 2011

Related U.S. Application Data
(63) Continuation-in-part of application No. 12/885,864, filed on Sep. 20, 2010.
(60) Provisional application No. 61/244,699, filed on Sep. 22, 2009.

(51) Int. Cl. B60B 33/00; B21D 53/26; F16C 33/58

(52) U.S. Cl. 16/46; 384/513; 29/894.36

(57) ABSTRACT

In one embodiment a bearing comprises an outer ring surrounding a central hub with inner and outer portions. In this embodiment, the inner portion is longer than the outer portion. The outer ring may be positioned between the inner portion and the outer portion of the central bearing hub. The outer ring may be offset relative to the center of the overall length of the bearing. A drive wheel may comprise a hub, a wheel portion, and a pair of bearings. In this embodiment, the wheel portion may be attached to an outer surface of the hub. The first bearing and the second bearing may be positioned within the hub such that an end of the first bearing abuts an end of the second bearing. In some embodiments, at least a portion of the first end of the hub and at least a portion of the second end of the hub are crimped inward.

### PRIORITY

This application is a continuation in part of and claims priority from U.S. patent application Ser. No. 12/885,864, filed Sep. 20, 2010, entitled Drive Wheel, which claims priority to U.S. Provisional Patent Application Ser. No. 61/244,699, filed Sep. 22, 2009, entitled “Drive Wheel.” The disclosures of both of these applications are incorporated by reference herein.

### BACKGROUND

In a factory or distribution warehouse, it may be desirable to move loads along a transporting path that is predominately horizontal, but which may also involve travel uphill, downhill, diversion between subpaths, and the like. Overhead conveyor systems allow such movement. The systems may comprise rotating drive tubes, a carriage that is supported by the drive tube or a fixed support rail, and a carriage that has skewed drive wheels to engage with the rotating drive tube. The engagement of the skewed drive wheels with the rotating drive tube propels the carriage along the rotating drive tube or along a fixed rail.

Typical drive wheels may be unable to handle situations where a heavy load is carried by the carriage as the carriage travels along the drive tube or a fixed support rail. Additionally, typical wheels may not provide a coefficient of friction substantial enough to facilitate proper movement of a carriage along the conveyor path system.

While a variety of drive wheels have been made and used, it is believed that no one prior to the inventor has made or used an invention as described herein.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts a front view of a prior art drive wheel.

FIG. 2 depicts a side, cross-sectional view of the prior art drive wheel of FIG. 1 taken along line 2-2.

FIG. 3 depicts a front view of an exemplary drive wheel.

FIG. 4 depicts a side, cross-sectional view of the drive wheel of FIG. 3 taken along line 4-4.

FIG. 5 depicts a front view of the hub of the drive wheel of FIG. 3.

FIG. 6 depicts a side, cross-sectional view of the hub of the drive wheel of FIG. 3 taken along line 6-6.

FIG. 7 depicts a front view of an alternate exemplary drive wheel.

FIG. 8 depicts a side, cross-sectional view of the drive wheel of FIG. 7.

FIG. 9 depicts a side view of the hub of the drive wheel of FIG. 7.

FIG. 10 depicts a side, cross sectional view of the hub of FIG. 9.

FIG. 11 depicts a side, cross-sectional view of the drive wheel shown in FIG. 7 with the hub having a crimped end.

FIG. 12 depicts a front view of an alternate exemplary drive wheel.

FIG. 13 depicts a side, cross-sectional view of the drive wheel of FIG. 12 taken along line 13-13.

FIG. 14 depicts a front view of the exemplary bearing incorporated within the drive wheel of FIG. 12.

FIG. 15 depicts a side, cross-sectional view of the bearing of FIG. 14.

FIG. 16 depicts a front view of the drive wheel of FIG. 12 with the hub having a crimped end.

FIG. 17 depicts a side, cross-sectional view of the drive wheel of FIG. 16 taken along line 17-17.

FIG. 18 depicts a side view of an exemplary crimping tool.

FIG. 19 depicts a front, cross-sectional view of the crimping tool of FIG. 18.

FIG. 20 depicts a front view of the crimping tool of FIG. 18.

FIG. 21 depicts a side view of the crimping tool of FIG. 18 in a different orientation.

FIG. 22 depicts a side view of an exemplary protrusion of the crimping tool of FIG. 18.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples should not be used to limit the scope of the present invention. Other features, aspects, and advantages of the versions disclosed herein will become apparent to those skilled in the art from the following description, which is by way of illustration, one of the best modes contemplated for carrying out the invention. As will be realized, the versions described herein are capable of other different and obvious aspects, all without departing from the invention. Accordingly, the drawings and descriptions should be regarded as illustrative in nature and not restrictive.

Embodiments of the present drive wheel may be used in heavy duty conveyor systems, particularly overhead conveyor systems with a carriage suspended therefrom and a rotating drive tube configured to drive the carriage along the overhead conveyor system by contact with drive wheels. Of course, other suitable uses for various embodiments will be apparent to those of ordinary skill in the art based on the teachings herein. By way of example only, embodiments of the present drive wheels may be used in overhead conveyors of the type disclosed in U.S. Pat. No. 5,806,655 issued Sep. 15, 1998 to Tabler; U.S. Pat. No. 5,785,168 issued Jul. 28, 1998 to Beall, Jr.; U.S. Pat. No. 4,203,511 issued May 20, 1980 to Uhing; U.S. Pat. No. 3,164,104 issued Jan. 5, 1965 to Hunt; and U.S. Pat. No. 3,850,280 issued Nov. 26, 1974 to Ohrnell. The disclosures of each of these patents are incorporated by reference herein.

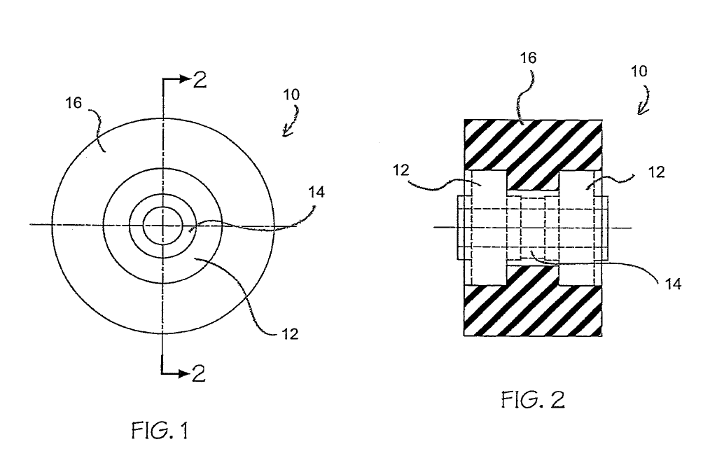

FIGS. 1 and 2 depict a prior art drive wheel (10). As shown, drive wheel (10) comprises a pair of standard commercial bearings (12) and a spacer (14) pressed into an outer wheel portion (16). In some embodiments, wheel portion (16) may comprise a high durometer urethane elastomer.

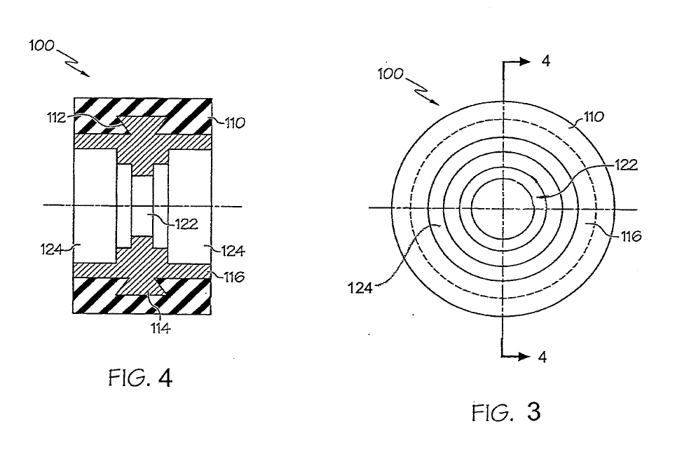

FIGS. 3 and 4 show an embodiment of a drive wheel (100) comprising a wheel portion (110) encircling a hub (116). In the illustrated embodiment, a spacer (122) and bearings (124) are positioned centrally within hub (116). By way of example only, spacer (122) and bearings (124) may be co-axially aligned with the central axis of hub (116), while also being substantially centered along the length of the central axis of hub (216). Hub (116) may comprise any suitable material configured to provide adequate engagement with wheel portion (110) while also providing adequate strength depending on the particular application of drive wheel (100), including but not limited to steel, aluminum, and engineering grade resin. Wheel portion (110) may comprise a high durometer urethane elastomer. However, other suitable materials for wheel portion (110) configured to provide adequate friction between drive wheel (100) and a corresponding drive tube while also having satisfactory wear properties may be used, including but not limited to rubber, vulcanized rubber, and any other materials suitable for casting or injection molding. In the illustrated embodiment, wheel portion (110) comprises a generally cylindrical shape. However, as shown, the inner surface of wheel portion (110) includes an engagement recess (112). As shown, engagement recess (112) is centered along a longitudinal axis of wheel portion (110). Of course other suitable locations for engagement recess (112) may be apparent to those of ordinary skill in the art based on the teachings herein. In this embodiment, engagement recess (112) is configured to correspond with and receive engagement member (114) extending from the outer surface of hub (116), which is described in more detail below. As shown in FIGS. 3-6, hub (116) comprises an engagement member (114) along the outside of hub (116). In this embodiment, engagement member (114) is shaped to correspond to engagement recess (112) of wheel portion (110) and extends outwardly from the outer surface of hub (116). Similar to engagement recess (112), engagement member (114) is centered along the longitudinal axis of hub (116), but this positioning is not necessarily required. As shown, engagement recess (112) and engagement member (114) comprise a dovetail shape. Of course, other shapes, sizes and configurations for engagement recess (112) and engagement member (114) may be used, as long as they facilitate engagement between wheel portion (110) and hub (116). In other embodiments (not shown), the engagement recess may be formed in the hub and the wheel portion may comprise a corresponding engagement member.

A satisfactory engagement or attachment between hub (116) and wheel portion (110) may be achieved using any suitable method or combination of methods. By way of example only, in some embodiments hub (116) and wheel portion (110) may include a mechanical engagement, such as the engagement recess and engagement member structures described above. Of course, other shapes and means of mechanical engagement may be used. In still other embodiments, the outer surface of hub (116) may be machined or sandblasted so as to increase the bond strength between the outer surface of hub (116) and wheel portion (110), particularly when wheel portion (110) comprises an elastomeric material. Other embodiments may utilize an adhesive applied between hub (116) and wheel portion (110). Finally, still other embodiments may include a combination of these attachment methods, including but not limited to using an adhesive and a mechanical engagement together, to provide an adequate attachment between hub (116) and wheel portion (110).

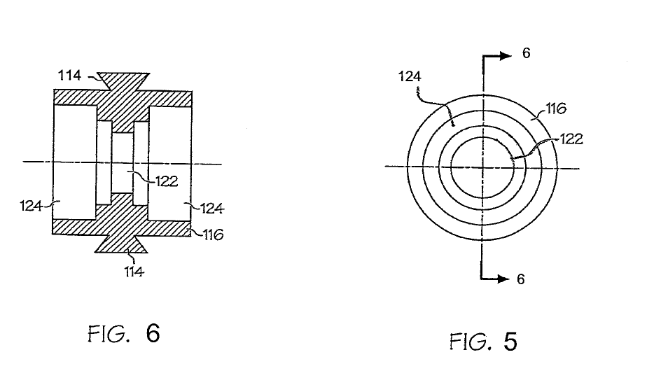

In the illustrated embodiment, hub (116) is shaped to receive spacer (122) and bearings (124). As shown in FIG. 4, spacer (122) fits between bearings (124) and hub (116) comprises contours shaped to fit the contours of bearings (124) and spacer (122). In some embodiments, the components may be configured to provide a press fit among hub (116), bearings (124) and spacer (122). As shown, both bearings (124) and spacer (122) are co-axially aligned with the central axis of hub (116). FIGS. 5 and 6 show hub (116), spacer (122), and bearings (124) without wheel portion (110) surrounding hub (116).

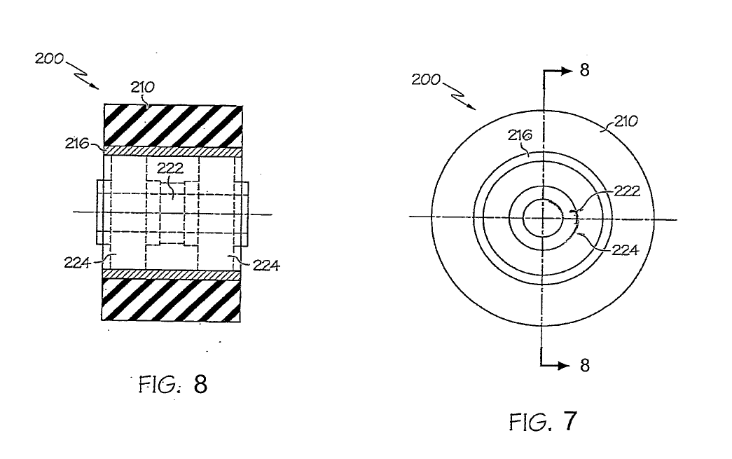

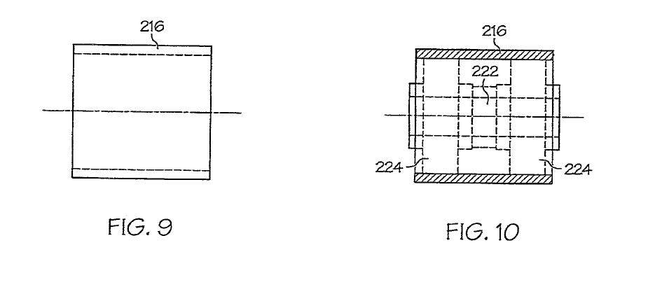

FIGS. 7-11 depict an alternate embodiment of a drive wheel (200) comprising a wheel portion (210) surrounding a hub (216). As shown, a spacer (222) and two bearings (224) are positioned within hub (216).

As shown in FIGS. 7-11, hub (216) comprises a generally cylindrical interior cavity instead of the contoured shape of the interior cavity of hub (116) shown in FIGS. 3-6 and described above. In the illustrated embodiment, bearings (224) are inserted into the inner cavity (217) of hub (216) and spacer (222) is positioned between bearings (224). As shown, both bearings (224) and spacer (222) are co-axially aligned with the central axis of hub (216) and substantially centered along the length of the central axis of hub (216). In the illustrated embodiment, the length of hub (216) is such that the outer edges of hub (216) extend past the ends of bearings (224). However, any suitable length for hub (216) may be used as would be apparent to one of ordinary skill in the art in view of the teachings herein. For example, in some versions, the length of hub (216) may be of a length shorter or equal to the ends of bearings (224). Hub (216) may comprise any suitable material configured to provide adequate engagement with wheel portion (210) while also providing adequate strength depending on the particular application of drive wheel (200), including but not limited to steel and aluminum. In some versions, spacer (222) may be adjustable so as to allow bearings (224) to be moved closer or farther relative to one another.

Once bearings (224) are positioned within hub (216), the outer surface of each bearing (224) abuts the inner surface of hub (216) such that bearings (224) maintain a substantially tight engagement with hub (216). In some embodiments, the outer surface of bearings (224) may comprise a textured, machined, or treated surface to facilitate the engagement between hub (216) and bearings (224). In still other embodiments, the outer surface of bearings (224) may comprise a substantially smooth surface where the friction between bearings (224) and hub (216) is caused primarily by outward radial force applied by bearings (224) on hub (216) due to the size relationship between bearings (224) and hub (216). Furthermore, in some embodiments, bearings (224) may comprise an elastomeric material to provide friction between bearings (224) and hub (216) thereby facilitating engagement between those components. In still other embodiments, an adhesive may be applied between the outer surface of bearings (224) and the inner surface of hub (216). Of course, any suitable texture, surface treatment, adhesive or material for bearings (224) may be used provided it creates a satisfactory engagement between bearings (224) and hub (216) such that bearings (224) and spacer (222) substantially avoid moving laterally relative to hub (216) during use. In still other embodiments the inner surface of hub (216) may comprise a textured, machined or treated surface to facilitate the engagement between hub (216) and bearings (224).

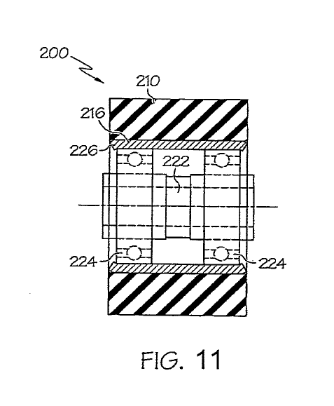

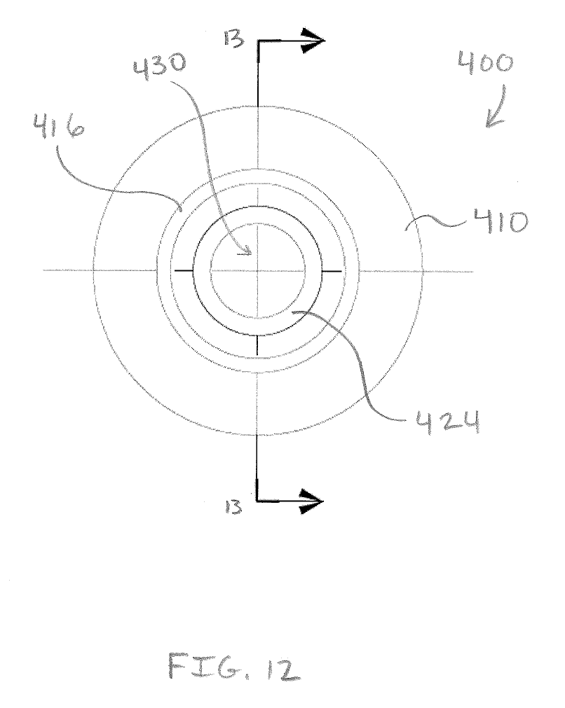

In the embodiment shown in FIG. 11, at least a portion of the outer edges of hub (216) are crimped to form crimped portions (226). The crimping may be accomplished after bearings (224) and spacer (222) are positioned within hub (216). In some embodiments, substantially the entire circumference of hub (216) may be crimped, however this is not required. As shown, crimped portion (226) is bent inward such that bearings (224) and spacer (222) can no longer be removed from hub (216). Crimped portions (226) may be formed by evenly crimping the outer edges of hub (216) around the circumference of hub (216). In some versions, crimped portions (226) may be formed by a plurality of crimping points along the circumference of hub (216) such that even though the entire circumference of hub (216) is not crimped, crimped end (226) holds in bearings (224) and spacer (222). In other words, crimped portions (226) may help lock bearings (224) and spacer (222) in place.

A satisfactory engagement or attachment between hub (216) and wheel portion (210) may be achieved using any suitable method or combination of methods. By way of example only, in some embodiments hub (216) and wheel portion (210) may include a mechanical engagement, such as the engagement recess and engagement member structures described above with regard to drive wheel (100). In other embodiments the outer surface of hub (216) may comprise a texture, may be machined, or may include an adhesive so as to provide a substantially tight engagement between wheel portion (210) and hub (216). In still other embodiments, the outer surface of hub (216) may be sandblasted in order to provide the necessary engagement between hub (216) and wheel portion (210). Finally, still other embodiments may include a combination of these attachment methods to provide an adequate attachment between hub (216) and wheel portion (210).

In some embodiments, wheel portion (210) may comprise a rubber compound. A rubber compound for wheel portion (210) may be used to aid in gripping between hub (216) and wheel portion (210). By way of example only, wheel portion (210) may comprise vehicular tire material, such as a vulcanized rubber compound. In embodiments where wheel portion (210) comprises a vulcanized rubber material, bearings (224) can be assembled in wheel portion (210) after the wheel portion (210) has been applied to hub (216) and the rubber material is vulcanized. In still other embodiments, wheel portion (210) may comprise a high durometer urethane elastomer.

Thus, one exemplary way of constructing drive wheel (200) may comprise the following steps. Please note that other suitable steps, orders of steps, and methods of fabrication, assembly and attachment may be apparent to those of ordinary skill in the art based on the teachings herein. First, bearings (224) and spacer (222) may be positioned within hub (216). As in the illustrated embodiments, bearings (224) and spacer (222) may be co-axially aligned with the central axis of hub (216). Second, the edges of hub (216) may be crimped so as to form crimped portions (226) along the circumference at each end of hub (216). Finally, hub (216), which contains bearings (224) and spacer (222), may then be assembled together with wheel portion (210) to form drive wheel (200). As mentioned above, in some embodiments, including but not limited to those where wheel portion (210) comprises a vulcanized rubber compound or a urethane elastomer compound, hub (216) may be assembled together with wheel portion (210) prior to inserting bearings (224) and spacer (222) into hub (216).

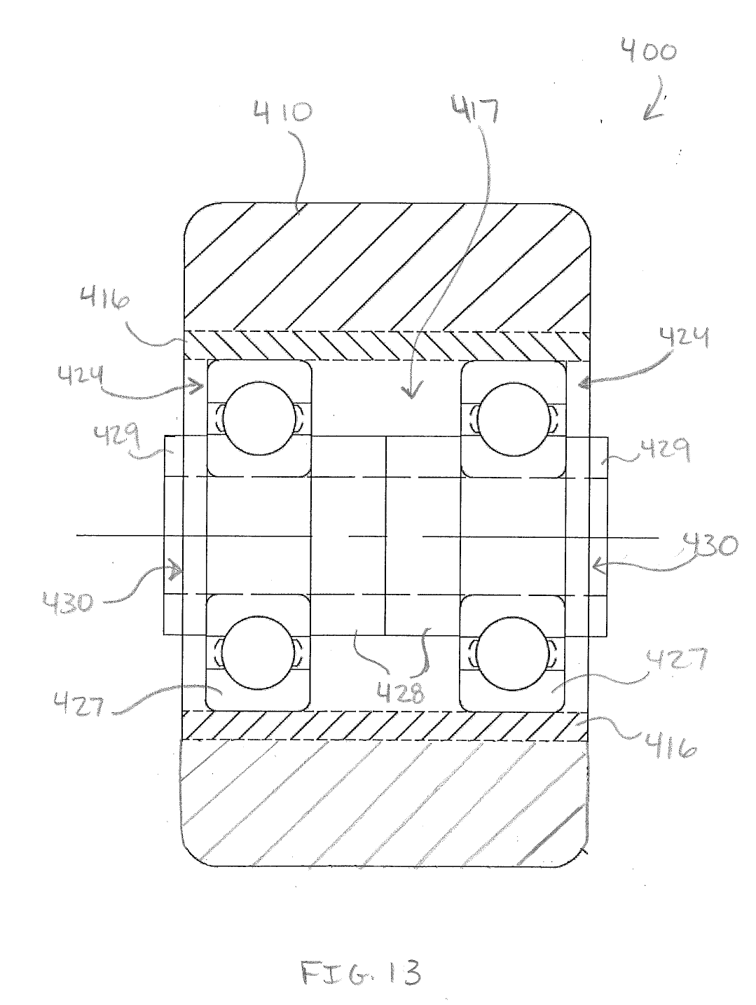

FIGS. 12-15 depict an alternate embodiment of a drive wheel (400) comprising a wheel portion (410) surrounding a hub (416). As shown, two bearings (424) are positioned within hub (416).

As shown in FIGS. 12-15, hub (416) comprises a generally cylindrical interior cavity instead of the contoured shape of the interior cavity of hub (116) shown in FIGS. 3-6 and described above. In some embodiments (not shown), a hub, such as hub (116) may be configured to receive bearings shaped like bearings (424). In the illustrated embodiment, bearings (424) are inserted into the inner cavity (417) of hub (416). As shown, bearings (424) are co-axially aligned with each other and with the central axis of hub (416) and substantially symmetrically positioned within the inner cavity (417) of hub (416).

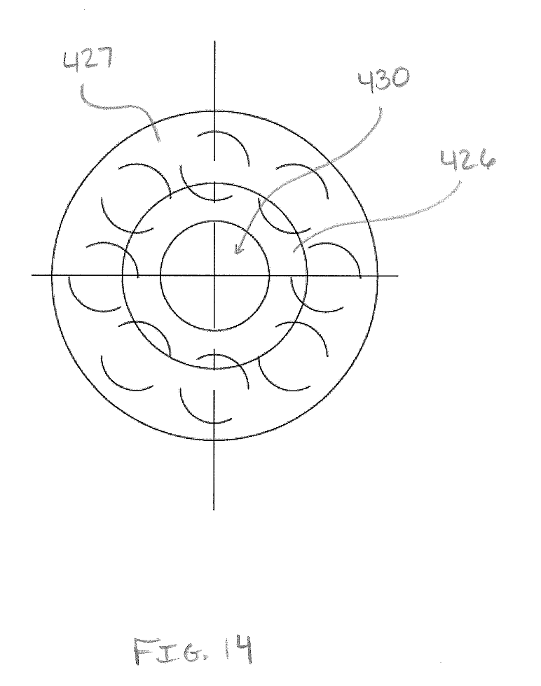

In the illustrated embodiment, each bearing (424) comprises a central bearing hub (426) surrounded by an outer ring (427). The central bearing hub (426) of each bearing (424) shown in FIGS. 12-15 is substantially cylindrical and includes an inner portion (428) and an outer portion (429) surrounding a central opening (430) that extends through the entire overall length (L3) of the bearing (424). As shown, the length (L1) of the inner portion (428) of the central bearing hub (426) is greater than the length (L2) of the outer portion (429). As a result, in the illustrated embodiments, the outer ring (427) of each bearing (424) is offset relative to the center of the overall length (L3) of the bearing (424). In other words, as shown, the outer ring (427) is not centered along the overall length (L3) of the bearing (424). As shown in FIGS. 13-14, the bearings (424) are positioned within the inner cavity (417) of hub (416) such that the interior ends of each of the inner portions (428) of each bearing (424) abut each other. The elimination of the spacer from the drive wheel may facilitate assembly and decrease the cost to produce a drive wheel, such as drive wheel (400). In an alternate embodiment (not shown), the hub (116) of drive wheel (100) described above may be modified to be able to receive bearings (424) instead of the bearings (124) and spacer (122) assembly shown in FIGS. 3-6 and described above. In some embodiments the bearings (424) comprise ball bearings, such as those shown in FIGS. 12-15. In other embodiments, such as applications involving heavier loads, the bearings may comprise roller bearings. In addition, the bearings may comprise commercial grade hardened steel or any other material configured to provide satisfactory functionality for the bearings.

In the illustrated embodiment, the length of hub (416) is such that the outer edges of hub (416) extend past the outer faces of the outer rings (427) of each of the bearings (424). However, any suitable length for hub (416) may be used as would be apparent to one of ordinary skill in the art in view of the teachings herein. For example, in some versions, the length of hub (416) may be of a length shorter or equal to the outer faces of the outer rings (427) of one or both of the bearings (424). Hub (416) may comprise any suitable material configured to provide adequate engagement with wheel portion (410) while also providing adequate strength depending on the particular application of drive wheel (400), including but not limited to steel and aluminum.

Once bearings (424) are positioned within hub (416), the outer surface (427a) of each outer ring (427) of each bearing (424) abuts the inner surface of hub (416) such that bearings (424) maintain a substantially tight engagement with hub (416). In some embodiments, the outer surface (427a) of each outer ring (427) may comprise a textured, machined, or treated surface to facilitate the engagement between hub (416) and bearings (424). In still other embodiments, the outer surface (427a) of each outer ring (427) may comprise a substantially smooth surface where the friction between bearings (424) and hub (416) is caused primarily by outward radial force applied by outer rings (427) on hub (416) due to the size relationship between bearings (424) and hub (416). Furthermore, in some embodiments, bearings (424) may comprise an elastomeric material to provide friction between bearings (424) and hub (416) thereby facilitating engagement between those components. In still other embodiments, an adhesive may be applied between the outer surface (427a) of outer rings (427) and the inner surface of hub (416). Of course, any suitable texture, surface treatment, adhesive or material for outer surface (427a) of each outer ring (427) may be used provided it creates a satisfactory engagement between bearings (424) and hub (416) such that bearings (424) substantially avoid moving laterally relative to hub (416) during use. In still other embodiments the inner surface of hub (416) may comprise a textured, machined or treated surface to facilitate the engagement between hub (416) and bearings (424).

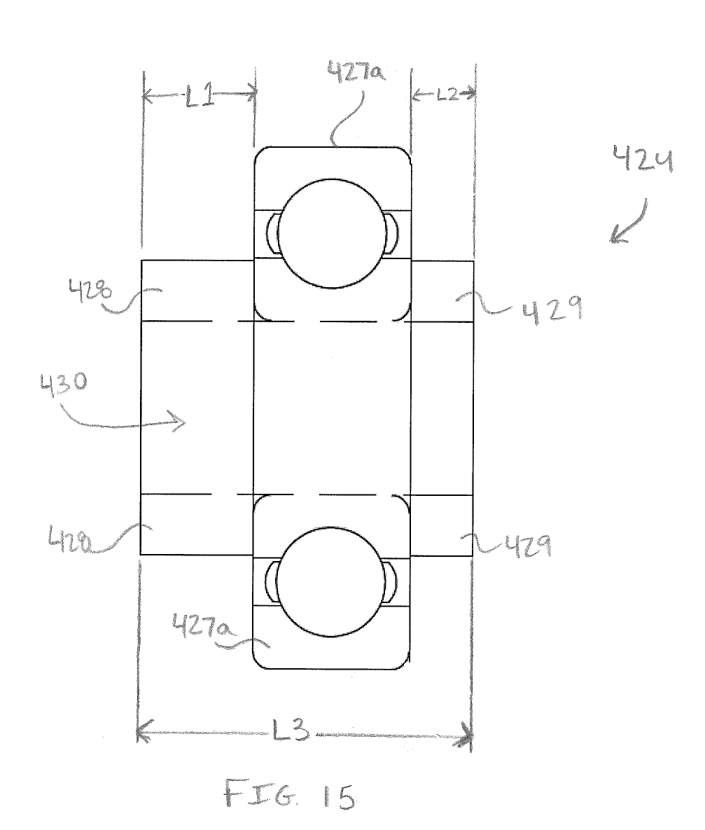

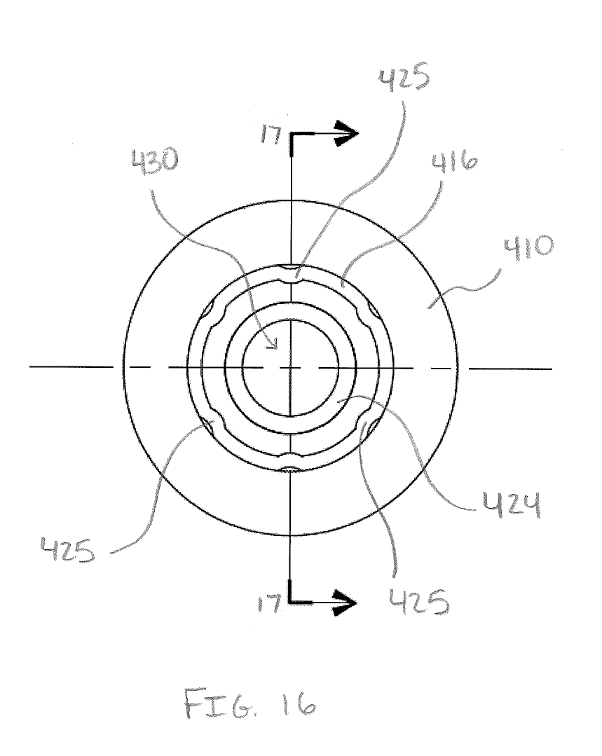

In the embodiment shown in FIGS. 16-17, at least a portion of the outer edges of hub (416) are crimped to form crimped portions (425). The crimping may be accomplished after bearings (424) are positioned within hub (416). In some embodiments, substantially the entire circumference of hub (416) may be crimped, however this is not required. As shown, crimped portion (425) is bent inward such that bearings (424) can no longer be removed from hub (416). Crimped portions (425) may be formed by evenly crimping the outer edges of hub (416) around the circumference of hub (416). In some embodiments, crimped portions (425) may be formed by a plurality of crimping points along the circumference of hub (416) such that even though the entire circumference of hub (416) is not crimped, the crimped end holds in bearings (424). In other words, crimped portions (425) may help lock bearings (424) in place.

A satisfactory engagement or attachment between hub (416) and wheel portion (410) may be achieved using any suitable method or combination of methods. By way of example only, in some embodiments hub (416) and wheel portion (410) may include a mechanical engagement, such as the engagement recess and engagement member structures described above with regard to drive wheel (100). In other embodiments the outer surface of hub (416) may comprise a texture, may be machined, or may include an adhesive so as to provide a substantially tight engagement between wheel portion (410) and hub (416). In still other embodiments, the outer surface of hub (416) may be sandblasted in order to provide the necessary engagement between hub (416) and wheel portion (410). Finally, still other embodiments may include a combination of these attachment methods to provide an adequate attachment between hub (416) and wheel portion (410).

Similar to wheel portion (210) described above, in some embodiments, wheel portion (410) may comprise a rubber compound. A rubber compound for wheel portion (410) may be used to aid in gripping between hub (416) and wheel portion (410). By way of example only, wheel portion (410) may comprise vehicular tire material, such as a vulcanized rubber compound. In embodiments where wheel portion (410) comprises a vulcanized rubber material, bearings (424) can be assembled in wheel portion (410) after the wheel portion (410) has been applied to hub (416) and the rubber material is vulcanized. In still other embodiments, wheel portion (410) may comprise a high durometer urethane elastomer.

Thus, one exemplary way of constructing drive wheel (400) may comprise the following steps. Please note that other suitable steps, orders of steps, and methods of fabrication, assembly and attachment may be apparent to those of ordinary skill in the art based on the teachings herein. First, bearings (424) may be positioned within hub (416). As in the illustrated embodiments, bearings (424) may be co-axially aligned with each other and with the central axis of hub (416) and positioned such that the interior ends of each of the inner portions (428) of each bearing (424) abut each other. Second, the edges of hub (416) may be crimped so as to form crimped portions (425) along the circumference at each end of hub (416). Finally, hub (416), which contains the bearings (424), may then be assembled together with wheel portion (410) to form drive wheel (400). As mentioned above, in some embodiments, including but not limited to those where the wheel portion (410) comprises a vulcanized rubber compound or a urethane elastomer compound, the hub (416) may be assembled together with the wheel portion (410) prior to inserting the bearings (424) into the hub (416).

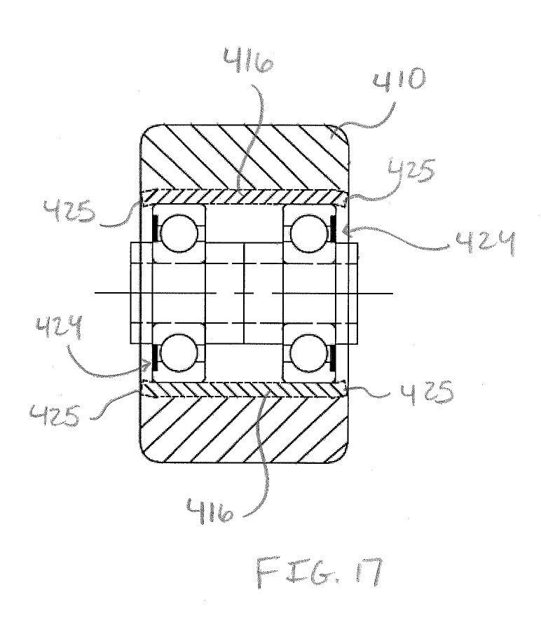

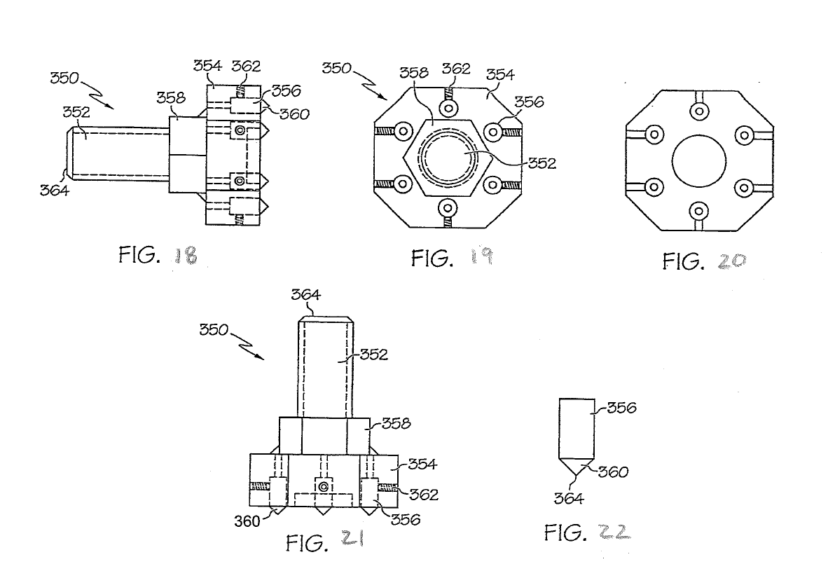

FIGS. 18-22 depict an embodiment of a tool (350) configured to aid in the assembly of a drive wheel. By way of example only, tool (350) may be used to assemble drive wheel (200) shown in FIGS. 7-11 and drive wheel (400) shown in FIGS. 12-17. In the illustrated embodiment, tool (350) comprises a shaft (352) and head portion (354). As shown, shaft (352) is attached to head portion (354) via a connecting member (358). Connecting member (358) may comprise any suitable connection device or component, including but not limited to a nut. Shaft (352) comprises a beveled end (364), but any suitable shaped end may be used as would be apparent to one of ordinary skill in the art in view of the teachings herein. Shaft (352) may be configured to allow tool (350) to be used with a standard punch press.

In the illustrated embodiment, head portion (354) comprises a plurality of protrusions (356) where each of the plurality of protrusions (356) comprises a chamfered tip (360). As shown, protrusions (356) are positioned around the circumference of head portion (354). Of course, other suitable arrangements or configurations may be apparent to those of ordinary skill in the art. In this embodiment, tip (360) comprises a generally conical shape having an approximately 45 degree angle. However, tip (360) may have any suitable shape configured to aid in crimping the edges of hub (216, 416).

As shown in FIGS. 18-21, head portion (354) further comprises a set screw (362) positioned transverse to the longitudinal axis of each of plurality of protrusions (356). In this embodiment each of the plurality of protrusions (356) has a set screw (362) associated with it. A specific set screw (362) may be loosened or removed in order to remove and/or replace the corresponding protrusion (356). Similarly, a specific set screw (362) may be tightened in order to secure a corresponding protrusion (356) to head portion (354). In some embodiments protrusions may be fixedly attached to head portion (354) and, consequently, may not be capable of being removed and replaced. Of course, other methods or devices configured to fixedly or releasably secure protrusions within head portion (354) may be used. In the illustrated embodiment, head portion (354) comprises six protrusions (356), but any suitable number may be used as would be apparent to one of ordinary skill in the art in view of the teachings herein. The plurality of protrusions (356) may be spaced about head portion (354) such that tip (360) of each of plurality of protrusions (356) corresponds to the circumference of hub (216, 416). Additionally, in some embodiments the plurality of protrusions (356) may comprise a hardened material such that plurality of protrusions (356) can crimp hub (216, 416) without being deformed themselves. Accordingly, protrusions (356) may be configured and arranged such that, if head portion (354) of tool (350) is pressed into hub (216, 416), at least a portion of the outer circumference of hub (216, 416) is crimped inward.

In one exemplary method of assembly, tool (350) may be used to assemble drive wheel (200). Please note that other suitable steps, orders of steps, and methods of fabrication, assembly and attachment may be apparent to those of ordinary skill in the art based on the teachings herein. First, two bearings (224) and spacer (22) may be positioned within hub (216). Second, that entire assembly (hub (216), bearings (224), and spacer (222)) may be placed on a stationary surface of a punch press (not shown). The stationary surface of the punch press may comprise a separate spacer configured to hold bearings (224) and spacer (222) in the proper position within hub (216). In other words, the separate spacer may be used to support bearings (224) so that bearings (224) are positioned approximately in the center of hub (216) when hub (216) is turned upon its end on the stationary surface. Once the hub (216), bearings (224) and spacer (222) are properly aligned on the stationary surface, then tool (350) is then aligned with hub (216) and lowered via a down stroke of the punch press onto hub (216). The plurality of protrusions (356) may engage at least a portion of the outside circumference of hub (216) and crimp at least portion of the outside edges of hub (216) inward. In some embodiments, wheel portion (210) may be attached to hub (216) prior to the crimping process. In these embodiments, the inner chamfered portions of protrusions (356) contact and crimp hub (216) while the outer chamfered portions of protrusions (356) may bury into the rubber or elastomeric material of wheel portion (210) without detaching hub (216) from wheel portion (210) or damaging material of wheel portion (210).

In another exemplary method of assembly, tool (350) may be used to assemble drive wheel (400). Please note that other suitable steps, orders of steps, and methods of fabrication, assembly and attachment may be apparent to those of ordinary skill in the art based on the teachings herein. First, two bearings (424) may be positioned within hub (416). Second, that entire assembly (hub (416) and bearings (424)) may be placed on a stationary surface of a punch press (not shown). The stationary surface of the punch press may comprise a separate spacer configured to hold bearings (424) in the proper position within hub (416). In other words, the separate spacer may be used to support bearings (424) so that bearings (424) are positioned approximately in the center of hub (416) when hub (416) is turned upon its end on the stationary surface. Once the hub (416) and bearings (424) are properly aligned on the stationary surface, then tool (350) is then aligned with hub (416) and lowered via a down stroke of the punch press onto hub (416). The plurality of protrusions (356) may engage at least a portion of the outside circumference of hub (416) and crimp at least portion of the outside edges of hub (416) inward. In some embodiments, wheel portion (410) may be attached to hub (416) prior to the crimping process. In these embodiments, the inner chamfered portions of protrusions (356) contact and crimp hub (416) while the outer chamfered portions of protrusions (356) may bury into the rubber or elastomeric material of wheel portion (410) without detaching hub (416) from wheel portion (410) or damaging material of wheel portion (410).

Having shown and described various versions in the present disclosure, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

What is claimed is:

1. A bearing comprising:
(a) a central bearing hub, wherein the central bearing hub further comprises an inner portion and an outer portion, wherein the inner portion and the outer portion each comprise a respective length, wherein the length of the inner portion is greater than the length of the outer portion;
(b) an outer ring, wherein the outer ring extends circumferentially around a portion of the central bearing hub, wherein the outer ring is positioned between the inner portion and the outer portion of the central bearing hub such that the outer ring is positioned offset relative to the center of the overall length of the bearing.

2. The bearing of claim 1, wherein the bearing further comprises a central opening that extends through the entire length of the central bearing hub.

3. The bearing of claim 1, wherein the central bearing hub is substantially cylindrical.

4. The bearing of claim 1, wherein the outer ring comprises a substantially circular cross-section.

5. A drive wheel comprising:
(a) a wheel portion, wherein the wheel portion comprises a generally cylindrical shape;
(b) a hub, wherein the hub comprises a generally cylindrical shape, wherein the hub comprises a first end, a second end, and a cylindrical opening extending through the hub, wherein the hub is positioned within the wheel portion, wherein the wheel portion is attached to an outer surface of the hub;
(c) a first bearing, wherein the first bearing is positioned within the cylindrical opening of the hub, wherein the first bearing engages an inner surface of the hub;
(d) a second bearing, wherein the second bearing is positioned within the cylindrical opening of the hub, wherein the second bearing engages the inner surface of the hub; and
wherein the first bearing and the second bearing are positioned within the hub such that an end of the first bearing abuts an end of the second bearing.

6. The drive wheel of claim 5, wherein the first bearing comprises an outer surface, wherein the outer surface of the first bearing is treated to facilitate the engagement between the first bearing and the hub.

7. The drive wheel of claim 5, wherein the hub comprises an inner surface, wherein the inner surface of the hub may be textured to facilitate the engagement between the first bearing and the hub.

8. The drive wheel of claim 5, wherein the wheel portion comprises a rubber compound.

9. The drive wheel of claim 8, wherein the wheel portion comprises a vulcanized rubber compound.

10. The drive wheel of claim 5, wherein the wheel portion comprises a urethane elastomer compound.

11. The drive wheel of claim 5, wherein at least a portion of the first end of the hub is crimped inward.

12. The drive wheel of claim 5, wherein at least a portion of the second end of the hub is crimped inward.

13. The drive wheel of claim 5, wherein the first bearing comprises a central bearing hub and an outer ring, wherein the central bearing hub of the first bearing further comprises a first inner portion and a first outer portion, wherein the outer ring of the first bearing is positioned between the first inner portion and the first outer portion of the central bearing hub of the first bearing, wherein the first inner portion and the first outer portion each comprise a respective length, wherein the length of the first inner portion is greater than the length of the first outer portion.

14. The drive wheel of claim 13, wherein an outer surface of the outer ring of the first bearing engages the inner surface of the hub.

15. The drive wheel of claim 13, wherein the second bearing comprises a central bearing hub and an outer ring, wherein the central bearing hub of the second bearing further comprises a second inner portion and a second outer portion, wherein the outer ring of the second bearing is positioned between the second inner portion and the second outer portion of the central bearing hub of the second bearing, wherein the second inner portion and the second outer portion each comprise a respective length, wherein the length of the second inner portion is greater than the length of the second outer portion.

16. The drive wheel of claim 15, wherein an outer surface of the outer ring of the second bearing engages the inner surface of the hub.

17. The drive wheel of claim 13, wherein the outer surface of the hub comprises an engagement member extending along at least a portion of the outer surface, and wherein the wheel portion comprises an engagement recess configured to receive the engagement member of the hub.

18. A method of assembling a drive wheel comprising:
(a) providing
(i) a hub, wherein the hub comprises
(1) a first circumferential end,
(2) a second circumferential end,
(3) an outer surface, and
(4) a substantially cylindrical interior cavity defined by an inner surface,
(ii) a first bearing comprising an outer surface,
(iii) a second bearing comprising an outer surface,
(iv) a wheel portion, and
(v) a tool, wherein the tool comprises
(1) a shaft comprising a first end and a second end,
(2) a head portion, wherein the head portion is attached to the first end of the shaft, wherein the head portion comprises a bottom surface, and
(3) a plurality of protrusions, wherein the plurality of protrusions are positioned circumferentially around bottom surface of the head portion, wherein at least a portion of each of the plurality of protrusions extends outward from the bottom surface of the head portion, wherein each of the plurality of protrusions includes a chamfered tip;
(b) attaching the wheel portion to the outer surface of the hub;
(c) positioning the first bearing within the interior cavity of the hub such that the outer surface of the first bearing is adjacent to the inner surface of the hub;
(d) positioning the second bearing within the interior cavity of the hub such that the second bearing abuts the first bearing, wherein the second bearing is co-axially aligned with the first bearing;
(e) crimping at least a portion of the first circumferential end of the hub inward toward the interior cavity, wherein the crimping step is accomplished by pressing the plurality of protrusions in the head portion of the tool onto at least a portion of the first circumferential end of the hub; and
(f) crimping at least a portion of the second circumferential end of the hub inward toward the interior cavity, wherein the crimping step is accomplished by pressing the plurality of protrusions in the head portion of the tool onto at least a portion of the first circumferential end of the hub.

19. The method of claim 18, wherein the tool further comprises a plurality of set screws, wherein each of the plurality of set screws is associated with a respective one of the plurality of projections.

20. The method of claim 18, wherein the plurality of projections in the tool are arranged to correspond to the circumferential size and shape of the hub.
